(19) United States
(12) Patent Application Publication
(10) Pub. No.: US 2003/0066257 A1
(43) Pub. Date: Apr. 10, 2003

(54) Method for manufacturing a door and door manufactured therefrom

(76) Inventor: Barry Shovlin, Selinsgrove, PA (US)

Correspondence Address: Joseph W. Berenato, III, Liniak, Berenato & White, LLC, Suite 240, 6550 Rock Spring Drive, Bethesda, MD, 20817, US

(21) Appl. No.: 10/263,349

(22) Filed: Oct. 3, 2002

Related U.S. Application Data
(60) Provisional application No. 60/326,726, filed on Oct. 4, 2001.

(51) Int. Cl. E04F 13/00; E04F 15/00; E04F 19/00; E06B 3/70

(52) U.S. Cl. 52/311.1; 52/455

(57) ABSTRACT

A solid core door with architectural features, such as raised panels, comprises a solid core door having planar opposed major surfaces. A groove is cut in at least one of the major surfaces. The groove has a bottom surface and side walls extending at an obtuse angle relative to the bottom surface. The groove may also extend arcuately from the bottom surface. In either case, the portion of the groove opening on the associated major surface has a dimension exceeding the corresponding dimension of the groove bottom surface. A trim piece is secured within the groove, which may overlie the edges of a veneer surface at the groove opening on the associated major surface.

### CROSS REFERENCE TO RELATED APPLICATIONS AND CLAIM TO PRIORITY

This is a nonprovisional application of provisional application, Ser. No. 60/326,726, filed Oct. 4, 2001, by Barry Shovlin, entitled Method for Manufacturing a Door and Door, the disclosure of which is herein incorporated by reference, and priority of which is claimed.

### FIELD OF THE INVENTION

The disclosed invention is a method for manufacturing a solid core door and a door resulting from the method having aesthetic architectural features as well as fire resistance and strength. The resulting door is capable of meeting standards imposed to receive a forty-five (45) minute fire rating, and can withstand the corresponding hose stream test. In addition, the door maintains its integrity following slam cycle testing. The door may be manufactured from a number of composite materials, including particleboard, timber strand, wood stave lumber, plywood, chipboard, medium density fiberboard, and mineral fire composite material.

### BACKGROUND OF THE INVENTION

Solid core entry doors are desirable for various reasons, including aesthetics, security, and ability to withstand fires. A fire door rating indicates how long the door assembly can withstand heat. Various tests have been designed for testing doors and are based on factors such as the time that a given door would withstand a certain temperature while maintaining its integrity. Hose stream tests assess the door's ability to withstand the forces of a high-pressure water stream after the door has been exposed to heat simulating that attributable to a fire. The water stream is cool relative to the door, thus subjecting the door to both mechanical stress from the impact force and thermal stress due to the relatively low temperature of the water stream. The water stream flows from a hose at a pressure approximately equal to the pressure at which fire-fighting hoses are operated. Erosion of the door core's depth is then measured.

The integrity of a door may also be tested by slam cycle testing, which assesses the door's ability to withstand normal use and abuse. The door is opened and closed roughly, or slammed, continuously over a period of time. The integrity of the door should be maintained following an extended period of opening and slamming.

In order to receive a fire rating, the door must have certain basic properties specified by standard industry-wide fire endurance tests, such as those in accordance with UL 10C (1998), NFPA 252 (1995), and UBC 7-2 (1997). In these tests, the door and frame are exposed to intense heat, such as that generated by fire in a burning building. Exemplary conditions of such tests involve exposing the door assembly to temperatures that progressively increase within the range of 1750° F. to 1800° F. for an exposure period up to 1½ hours. A door meeting these standards is rated as a 90-minute door. A fire door designed to be a 45-minute fire door according to tests in accordance with UL 10C (1998), NFPA 252 (1995), and UBC 7-2 (1997) is able to withstand exposure for at least twenty (20) minutes.

Basic properties that must be possessed by door cores during exposure to such tests are discussed below. The fire door typically has a core, which itself must have good integrity during exposure to fire. That is, it must resist heat transfer, burning, melting, spalling, cracking, bowing or deteriorating in any way which would cause the temperature, on the side of the door not exposed to the fire, to rise to the extent that the combustible veneer on the unexposed side of the door bums or chars substantially. In addition, the integrity of the door should be maintained following hose stream testing. The door's integrity must also be maintained following slam cycle testing.

During exposure to heat, the core must also exhibit good dimensional stability. It must remain relatively stable and resist warping or shrinking to the extent that it remains in contact with the banding (stiles and rails) around its perimeter. Separation from the banding can cause the combustible components to bum away prematurely, allowing fire to penetrate the opening.

Considerations in door design, in addition to fire rating and strength, also include cost of materials and fabrication, weight of the door, and aesthetic appearance. Aesthetic or architectural features are often desirable, but may adversely affect the fire rating and strength when implemented in solid core doors. Therefore, a solid core door frequently will have smooth, planar opposed major surfaces.

Consumers desiring doors having architectural features, such as raised panels, may purchase hollow core doors manufactured from molded door skins. Though hollow core doors may provide the desired architectural features, strength and integrity may be compromised. Therefore, attempts have been made to provide solid core doors having the architectural features of hollow core doors by securing a trim piece to the door in order to simulate a raised panel. Frequently, a square-edged groove is formed in the door to receive the trim piece. However, a square-edged groove creates a point of weakness, particularly when the door is exposed to slam cycle tests and fire rating tests. The square edges create points where stresses are maximized, potentially resulting in a failure of the door's ability to withstand exposure to flame or high-pressure water stream. Additionally, the stress points may cause the door to fail slam cycle testing.

Those skilled in the art will recognize a need for a solid core entry door having simulated raised panels or other architectural features, while maintaining its strength and that can receive a forty-five (45) minute fire rating. The disclosed invention meets these needs by providing a solid core entry door having simulated raised panels provided by trim pieces secured within a groove having an angled or non-square contour, which extends at an obtuse angle relative to the groove's bottom surface.

### DESCRIPTION OF THE DRAWINGS

FIG. 1 is an assembly drawing of an entry door according to the invention;

FIG. 2 is a fragmentary cross-sectional view of the core and trim piece according to the invention;

FIG. 3 is another fragmentary cross-sectional view of the core and trim piece according to the invention;

FIG. 4 is a fragmentary cross-sectional view of a trim piece useful with the invention;

FIG. 5 is a fragmentary cross-sectional view of a solid core useful with the invention;

FIG. 6 is another fragmentary cross-sectional view of a solid core useful with the invention;

FIG. 7 is a fragmentary cross-sectional view of a solid core and trim pieces on both opposed major surfaces of the solid core according to the invention;

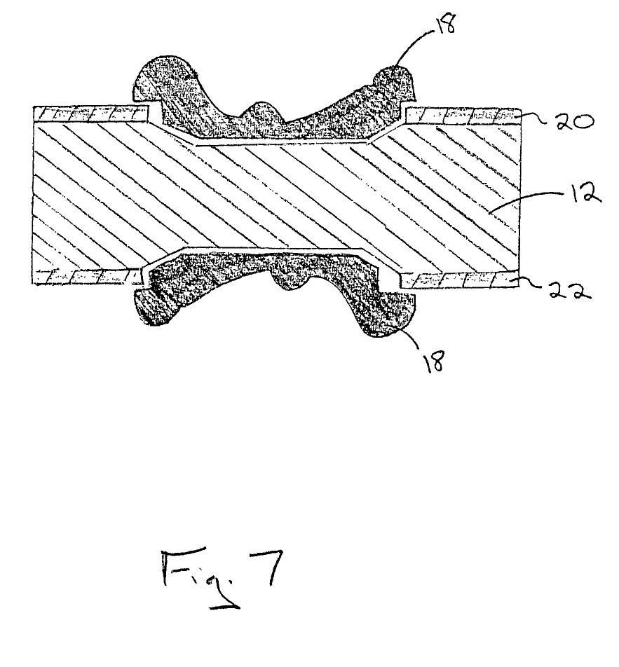

FIG. 8 is a drawing of a solid core door having a plurality of continuous grooves in the solid core useful with the invention;

FIG. 9 is another drawing of a solid core door having a plurality of noncontinuous grooves in the solid core useful with the invention; and

FIG. 10 is a drawing of a solid core door having continuous and non-continuous grooves in the solid core useful with the invention.

### DESCRIPTION OF THE INVENTION

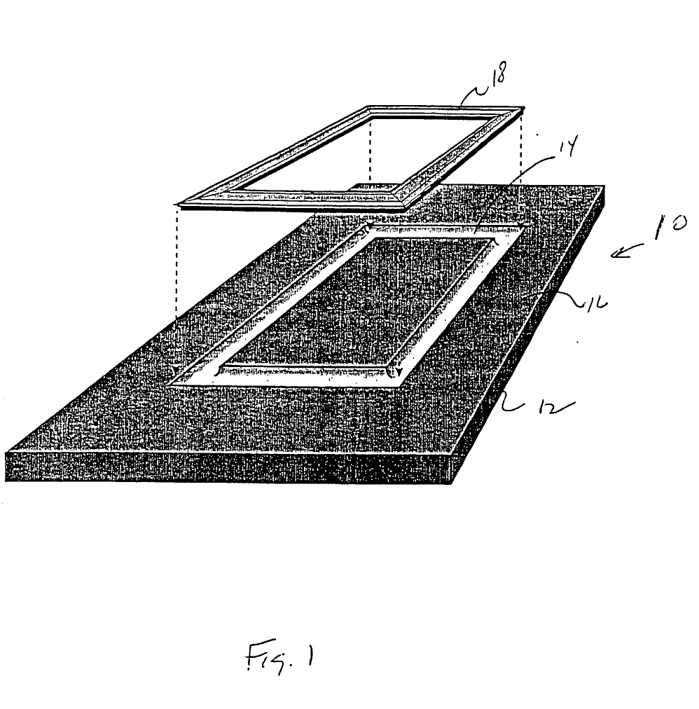

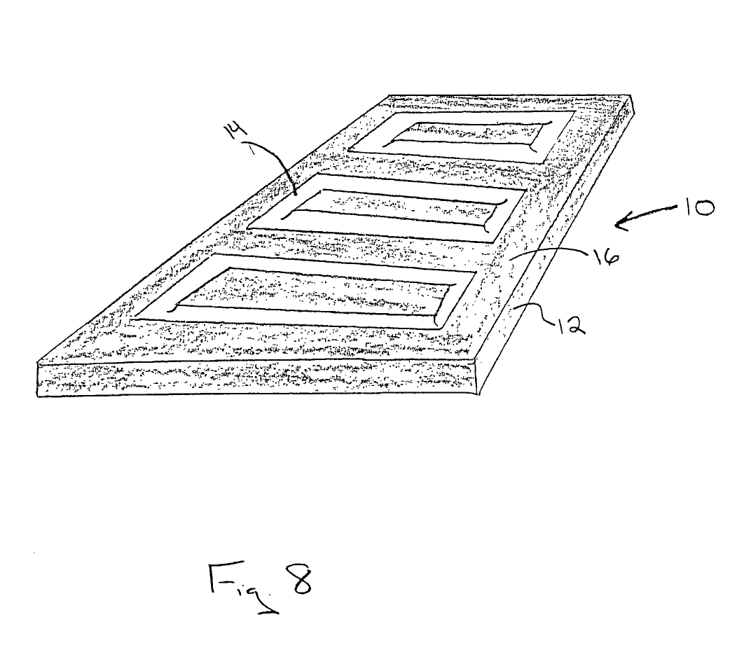

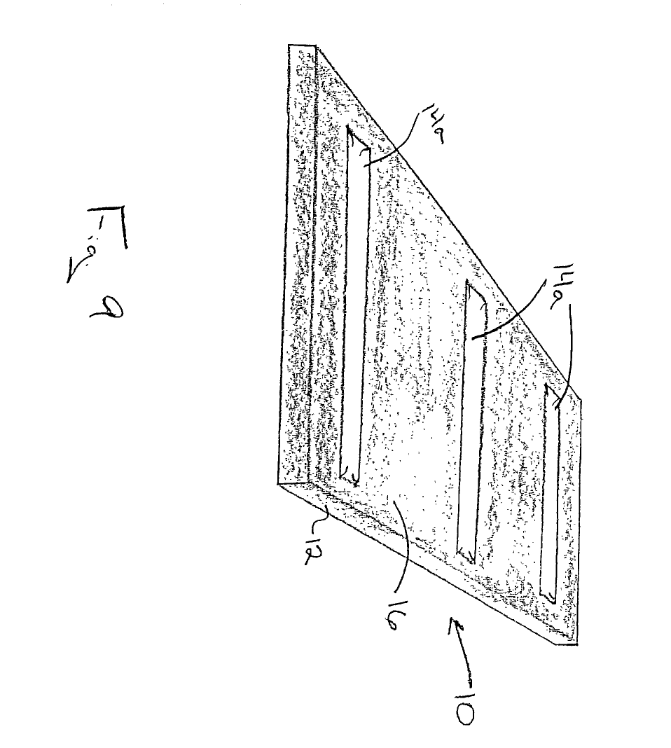

Door 10, as best shown in FIG. 1, includes a solid core 12 having a continuous groove 14 formed in major surface 16. The groove 14 extends generally about the periphery of door 10. While the groove 14 is shown to be rectangular in plan, it may have any desired shape. Furthermore, door 10 may have more than one continuous groove 14 formed in major surface 16, as shown in FIG. 8. Moreover, while groove 14 is shown as being continuous in FIGS. 1 and 8, it may be non-continuous. A plurality of non-continuous grooves 14a formed in major surface 16 is shown in FIG. 9. Trim piece 18 is sized to be received within groove 14. Trim piece 18 preferably is adhesively secured within groove 14, such as with polyvinyl acetate.

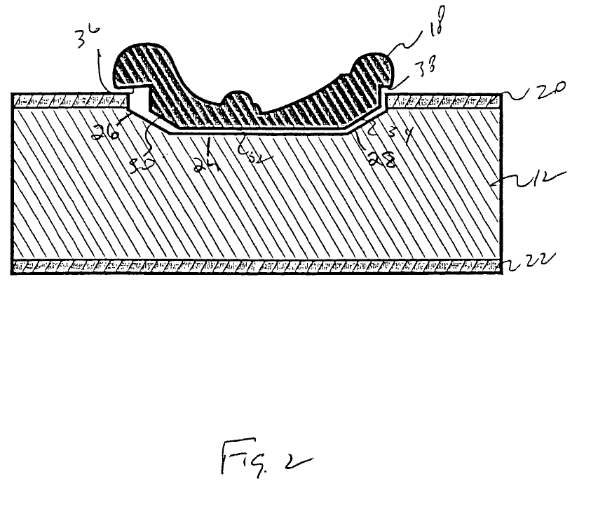

The core 12 preferably is formed from particleboard, timber strand, wood stave lumber, flake board, medium density fiberboard or mineral fire composite material. However, other composite material may be used, such as plywood or chipboard. The surface finish of those materials is generally not aesthetically acceptable to consumers, so preferably aesthetic surface layers 20 and 22 are secured to the major surfaces of core 12, as best shown in FIG. 2. Various materials may be used for aesthetic surface layers 20 and 22 such as veneers, medium density fiberboard (MDF), high density composite door skin, or plastic laminate. Any combination of core material and aesthetic surface layer may be used. The door 10 thus might have any color, texture, or other decorative aspect as may be desired.

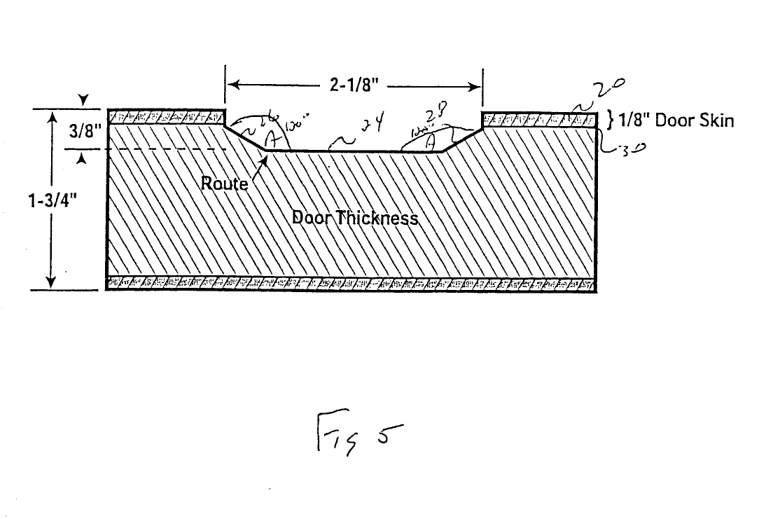

Groove 14, as shown in FIG. 5, has bottom surface 24 from which surfaces 26 and 28 extend angularly. The angled surfaces 26 and 28 terminate at surface 30, below aesthetic surface layer 20. The surfaces 26 and 28 preferably extend at an obtuse angle of 120° relative to surface 24. The angle A, of 120°, is sufficiently large as to preclude the sharp comers that permit stress concentrations arising in the prior art.

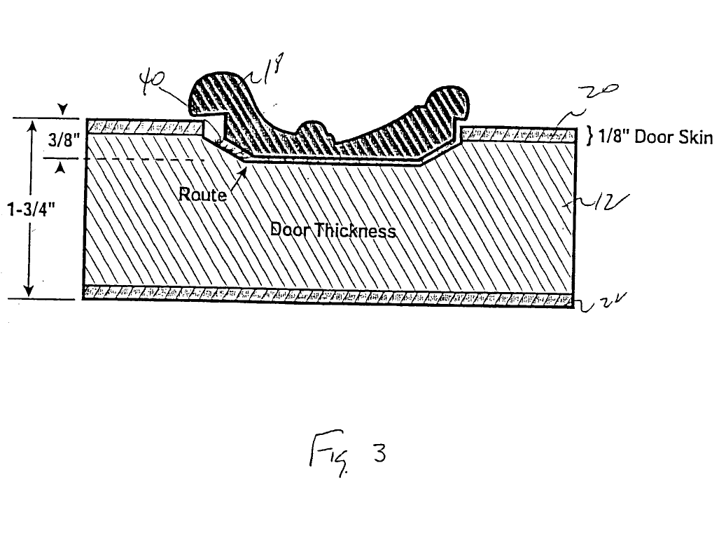

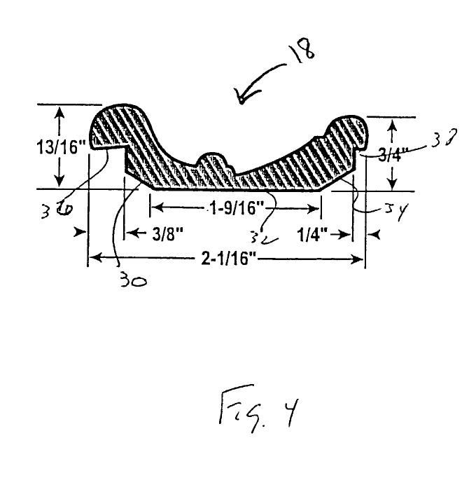

Trim piece 18 has surfaces 30, 32 and 34, as shown in FIG. 4. The surfaces 30, 32, and 34 are secured to surfaces 24, 26, and 28, as shown in FIG. 3. With this orientation, maximum securement can be achieved with a minimal depth to groove 14. Because the groove 14 is less deep than with square groove designs, fire resistance and strength are increased by providing added core.

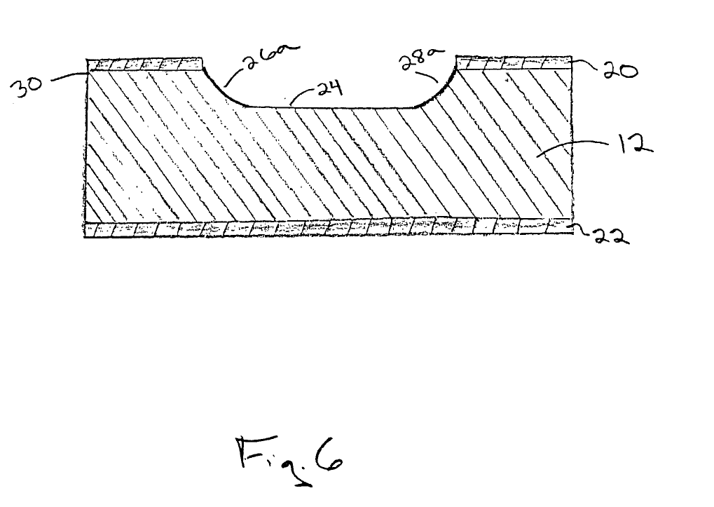

The groove 14 may be formed in core 12 by a high-speed rotary router. The cutting element of the router is configured to form the groove 14 with the angled extension surfaces 26 and 28. While a preferred angle A is 120°, a greater or lesser angle may be used, provided it prevents the high stress concentrations that cause failures. Moreover, while surfaces 26 and 28 are preferably angled, those surfaces might be arcuate or otherwise configured. Groove 14 with arcuate surfaces 26a and 28a is shown in FIG. 6.

As best shown in FIG. 2, surfaces 30, 32 and 34 of trim piece 18 conform to surfaces 26, 24, and 28, respectively of groove 14. Also, lips 36 and 38 extend from surfaces 30 and 34, in order to overlie veneer 20 at the intersection with groove 14. The trim piece 18 may fit snugly into the groove 14, and secure the veneer 20 at the intersection with groove 14, as shown in FIG. 3. The router used to form groove 14 may leave a roughened surface in veneer 20, so the lips 36 and 38 overlap and thereby mask the roughened surface and provide a pleasing configuration and appearance.

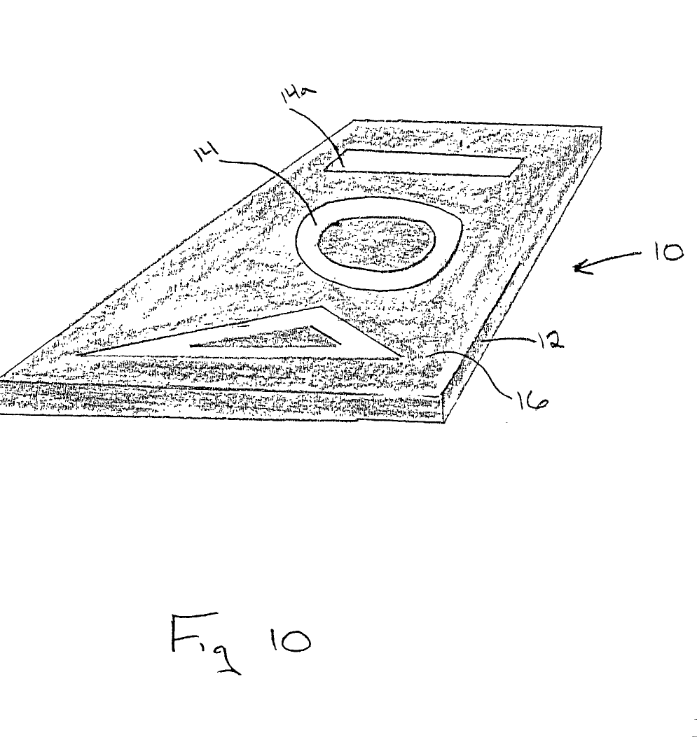

The trim piece 18 preferably is adhesively secured at 40, as shown in FIG. 3. The adhesive preferably is polyvinyl acetate or some other adhesive that secures trim piece 18 to core 12. The trim piece 18 may also be mechanically secured, such as with headless brads, nails, screws, etc. Also, while the trim piece 18 is shown for a single panel door, the invention may be implemented with 2 panel, 3 panel, 4 panel, 5 panel, 6 panel doors, or more. Thus, the invention may be implemented on doors having any number of panels. For example, FIG. 8 shows a door having three panels. Moreover, the invention may be implemented with non-continuous grooves 14a, as shown in FIG. 9. Any number of non-continuous grooves 14a may be formed in solid core 12. This invention may also be implemented with grooves 14 and 14a in any design, with trim pieces fitted and secured as noted above, as shown in FIG. 10.

While this invention has been described as having preferred designs, it is understood that the invention is not limited to the illustrated and described features. To the contrary, the invention is capable of further modifications, usages, and/or adaptations following the general principles of the invention and therefore includes such departures from the present disclosure as come within known or customary practice in the art to which the invention pertains, and as may be applied to the central features set forth above without departing from the spirit and scope of the invention, and which fall within the scope of the appended claims.

What is claimed is:

1. A solid core door with architectural features, comprising:
a solid core door having planar opposed major surfaces;
a groove in at least one of the major surfaces, said groove having a bottom surface and side walls extending at an obtuse angle relative to said bottom surface; and
a trim piece secured within said groove.

2. The door of claim 1, wherein the core of said door is selected from the group consisting of particleboard, composite wood, plywood, chipboard, timber strand, wood stave lumber, flake board, medium density fiberboard, and mineral fire composite material.

3. The door of claim 2, further comprising an aesthetic surface layer secured to said at least one major surface, said groove extends through said aesthetic surface layer and into said at least one major surface.

4. The door of claim 3, wherein said aesthetic surface layer is selected from the group consisting of veneer, medium density fiberboard, high density composite door skin, and plastic laminate.

5. The door of claim 4, wherein said trim piece has opposed side surfaces and lips outwardly extending from said side surfaces so that said lips overlie an edge of said aesthetic surface layer proximate said groove.

6. The door of claim 1, wherein said side walls extend from said bottom surface at an angle of substantially 120° relative to said bottom surface.

7. The door of claim 1, wherein said groove extends continuously in said at least one major surface.

8. The door of claim 7, wherein said door comprises a plurality of continuous grooves in said at least one major surface.

9. The door of claim 8, wherein said door comprises a plurality of continuous grooves in both opposed major surfaces.

10. The door of claim 1, wherein said door comprises at least one non-continuous groove in said at least one major surface.

11. A solid core door with architectural features, comprising:
a solid core door having planar opposed major surfaces;
a groove in at least one of the major surfaces, said groove having first and second portions, said first portion opening on the associated major surface and said first portion having a dimension exceeding the corresponding dimension of said second portion; and
a trim piece secured within said groove.

12. The door of claim 11, wherein the core of said door is selected from the group consisting of particleboard, composite wood, plywood, chipboard, timber strand, wood stave lumber, flake board, medium density fiberboard, and mineral fire composite material.

13. The door of claim 12, further comprising an aesthetic surface layer secured to said at least one major surface, said groove extends through said aesthetic surface layer and into said at least one major surface.

14. The door of claim 13, wherein said aesthetic surface layer is selected from the group consisting of veneer, medium density fiberboard, high density composite door skin, and plastic laminate.

15. The door of claim 14, wherein said trim piece has opposed side surfaces and lips outwardly extending from said side surfaces so that said lips overlie an edge of said aesthetic surface layer proximate said groove.

16. The door of claim 11, wherein said groove extends continuously in said at least one major surface.

17. The door of claim 16, wherein said door comprises a plurality of continuous grooves in said at least one major surface.

18. The door of claim 17, wherein said door comprises a plurality of continuous grooves in both opposed major surfaces.

19. The door of claim 11, wherein said door comprises at least one non-continuous groove in said at least one major surface.

20. The door of claim 11, wherein an arcuate surface extends between said first portion and said second portion.

21. A solid core door with architectural features, comprising:
a composite material door having planar opposed major surfaces;
a medium density fiberboard door skin secured to at least one major surface;
a groove through said skin and in at least one of the major surfaces, said groove having first and second portions, said first portion opening on the associated major surface and said first portion having a dimension exceeding the corresponding dimension of said second portion; and
a trim piece secured within said groove.

22. A method of producing a solid core door with architectural features, comprising the steps of:
providing a door blank having planar opposed major surfaces;
cutting a groove in at least one major surface so that the groove has a bottom surface and side walls extending at an obtuse angle relative to the bottom surface; and
securing a trim piece within the groove.

23. The method of claim 22, including the step of cutting the groove with a high-speed router.

24. The method of claim 23, including the step of cutting the groove with a cutting tool so that the side walls extend at an obtuse angle of substantially 120° relative to the bottom surface.

25. The method of claim 22, including the step of adhesively securing the trim piece in the groove.

26. The method of claim 22, including the step of mechanically securing the trim piece in the groove.

27. The method of claim 22, comprising the further steps of securing an aesthetic surface layer to the at least one major surface, and cutting the groove through the aesthetic surface layer and into the at least one major surface.

28. The method of claim 27, including the step of overlying the aesthetic surface layer with the trim piece.
